(19) United States
(12) Patent Application Publication
(10) Pub. No.: US 2003/0034076 A1
(43) Pub. Date: Feb. 20, 2003

(54) Spool valve for controlling oil pressure

(76) Inventor: Hyun-Suk Kim, Kyungki-Do (KR)

Correspondence Address: Pennie & Edmonds, LLP, 3300 Hillview Avenue, Palo Alto, CA, 94304, US

(21) Appl. No.: 10/214,293

(22) Filed: Aug. 6, 2002

(30) Foreign Application Priority Data
Aug. 20, 2001 (KR) 2001-50032

(51) Int. Cl. F16K 11/07

(52) U.S. Cl. 137/625.48

(57) ABSTRACT

A spool valve may comprise a valve body having a plurality of ports and a body chamber connected to the ports; a valve body socket inserted into the body chamber, including a plurality of ports connected to the ports at the valve body, respectively, and a socket chamber connected to the ports. A valve spool is movably inserted into the socket chamber, and includes a plurality of lands disposed at predetermined gaps with grooves formed between the lands for selectively connecting one port to the other port at the valve body via the socket chamber.

### BACKGROUND OF THE INVENTION

The present invention relates to a spool valve for controlling oil pressure, and more particularly, to a spool valve with a press-fit spool socket within the valve body.

### DESCRIPTION OF THE PRIOR ART

Generally, a spool valve comprises a valve body formed with a chamber connected to a plurality of ports for supplying oil pressure from one side to the other side. A valve spool, which comprises a plurality of lands and grooves formed between the lands, is inserted into the chamber of the valve body. When the valve spool is axially moved by the oil pressure control, oil pressure is supplied or stopped from one port to another port by the movement of the valve spool. The oil flow is supplied from one port to another through the groove formed between the lands.

However, a problem with the valve body thus described is that when manufactured as an aluminum casting a new mold design is required in order to reconfigure the interval between ports or areas of the ports. Also, oil leakage can occur between the valve body and valve spool, which causes control performance of the valve to decrease because the valve body is frequently made of aluminum while the valve spool is made of carbon steel. As a result, the two different metals generate different volumetric changes in response to temperature variation of the fluid.

### SUMMARY OF THE INVENTION

The present invention provides a spool valve for controlling oil pressure adapted to dispense with a separate mold manufacturing when the design of the valve is altered, and to prevent leakage between a valve body and a valve spool, thereby improving control performance of the oil pressure.

In accordance with an embodiment of the present invention, a spool valve for controlling oil pressure comprises a valve body having a plurality of ports and a body chamber connected to the ports. A valve body socket is inserted into the body chamber, which includes a plurality of ports connected to the ports at the valve body, respectively, and a socket chamber connected to the ports. A valve spool is movably inserted into the socket chamber. The spool includes a plurality of lands disposed at predetermined gaps and grooves formed between the lands for selectively connecting one port to another port at the valve body via the socket chamber.

### BRIEF DESCRIPTION OF THE DRAWINGS

For fuller understanding of the nature and objects of the invention, reference should be made to the following detailed description taken in conjunction with the accompanying drawings in which:

FIG. 1 is an exploded perspective view illustrating a spool valve for controlling oil pressure according to the present invention;

FIG. 2 is a sectional view taken along line II—II of FIG. 1;

FIG. 3 is a detailed sectional view illustrating a valve body socket of a spool valve for controlling oil pressure according to the present invention; and

FIG. 4 is a schematic diagram illustrating the action of a spool valve for controlling oil pressure according to the present invention.

### DETAILED DESCRIPTION OF THE INVENTION

Hereinafter, the preferred embodiments of the present invention will be described in detail with reference to the accompanying drawings.

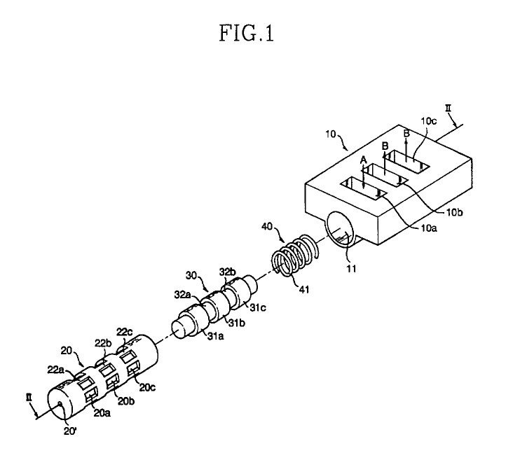

As shown in FIG. 1, the spool valve for controlling oil pressure according to the present invention includes a valve body 10, a valve body socket 20 fixedly inserted into the valve body 10 and a valve spool 30 mounted inside the valve body socket 20. A resilient member 40 is also provided, acting on valve spool 30 as described below.

The valve body 10 defines an inlet port 10a into which oil pressure is introduced (A), and outlet ports 10b and 10c from which the oil pressure supplied from the inlet port 10a is discharged (B). The valve body 10 is not only limited to formation of the inlet port 10a and outlet ports 10b and 10c, but also includes all other formation of a plurality of inlet ports and outlet ports performing the aforesaid actions. The valve body 10 is further formed at one lateral surface thereof with a body chamber 11 having a cylindrical shape in cross-sectional view, communicating with the inlet port 10a and the outlet ports 10b and 10c.

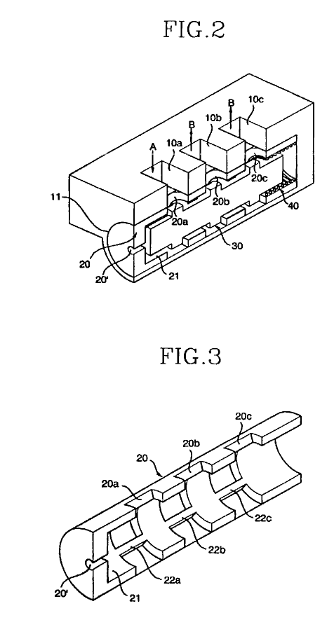

The valve body socket 20, which is cylindrical, is forcibly fitted into the body chamber 11 of the valve body 10. The valve body socket 20 is also formed with a plurality of ports 20a, 20b and 20c at a circumferential area opposite to the ports 10a, 10b and 10c. The valve body socket 20 is formed with a socket chamber 21 therein (FIG. 2) which communicates with ports 20a, 20b and 20c and into which the valve spool 30 is inserted.

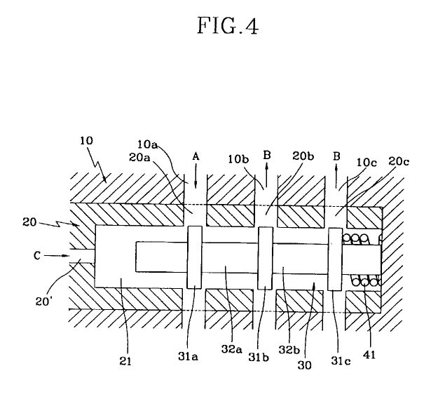

As shown in FIGS. 2 and 3, the socket chamber 21 is formed at one end thereof with a control port 20′ where oil pressure is supplied (C in FIG. 4). Guide portions 22a, 22b and 22c also connect each gapped portion of the ports 20a, 20b and 20c at the valve body socket 20, thereby guiding easy sliding movement of the valve spool 30.

The valve spool 30, inserted into the socket chamber 21 of the valve body socket 20, slides horizontally depending on the oil pressure. The valve spool 30 is also formed with a plurality of lands 31a, 31b and 31c in order to supply oil pressure provided from one side to the other side. Grooves 32a and 32b are formed between the lands.

The valve body socket 20 is made of the same material as the valve spool 30 such that the volumetric change therebetween in response to temperature variations are identical. By way of example, the valve body socket 20 is made of carbon steel, the same material as the valve spool 30.

The resilient member 40 is disposed at a side opposite to the side where the oil pressure is provided in the socket chamber 21 such that the valve spool 30 slides horizontally by mutual action and reaction. The resilient member 40 can be formed by a round coil spring 41.

Hereinafter, the operation of the spool valve for controlling oil pressure according to the present invention will be described.

As shown in FIG. 4, when the valve spool 30 is axially moved by oil pressure supplied through control port 20′, oil pressure supplied to the inlet ports 10a and 20a of the valve body 10 and the valve body socket 20, respectively, passes through the grooves 32a and 32b of the valve spool 30 to be discharged through the outlet ports 10b, 10c, 20b and 20c of valve 10 and the valve body socket 20, respectively.

If it is the designer's intention to alter the gaps between the ports and the size of the ports in the valve body 10, only the design of the valve body socket 20 needs to be changed. Then the valve spool 30 and the round coil spring 41 are inserted into the socket chamber 21 and the valve body socket 20 is press-fit into the body chamber 11. The designer's intention can be accomplished by merely changing the design of the valve body socket 20 without manufacturing a new mold for the valve body 10.

Because the guide portions 22a, 22b and 22c are formed between the ports 20a, 20b and 20c of the valve body socket 20, the valve spool 30 is easily guided by the guide portions 22a, 22b and 22c to prevent stickage of the valve spool 30.

The valve body socket 20 is made of the same carbon steel as that of the valve spool 30 to allow volumetric changes in response to temperature variations to be identical, such that leakage between the valve body 10 and valve spool 30 can be prevented.

The valve body socket 20 is preferably press-fit into the valve body 10, thereby dispensing with separate mounting parts to the valve spool 30 such as stoppers and the like. Sliding contact is made possible in the entire region where the valve spool 30 is moved by the guide portions of the valve body socket 20, thereby eliminating any separate sleeves.

The foregoing descriptions of specific embodiments of the present invention are presented for purposes of illustration and description. They are not intended to be exhaustive or to limit the invention to the precise forms disclosed. Obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A spool valve for controlling oil pressure, the valve comprising:
a valve body having a plurality of ports and a body chamber communicating with the ports;
a valve body socket inserted into the body chamber defining a plurality of socket ports communicating with the ports in the valve body, respectively, and a central socket chamber communicating with the socket ports; and
a valve spool movably inserted into the socket chamber having a plurality of lands disposed at predetermined gaps with grooves formed between the lands for selectively connecting one port to another port in the valve body via the socket chamber.

2. The spool valve as defined in claim 1, wherein said socket chamber is formed with guide portions extending across the socket ports, thereby facilitating sliding of the valve spool.

3. The spool valve as defined in claim 1, wherein said valve body socket is made of the same material as said valve spool such that volumetric changes therebetween in response to temperature variations are minimized.

4. The spool valve as defined in claim 3, wherein said valve body socket is made of carbon steel, the same material as said valve spool.

5. The spool valve as defined in claim 1, wherein said socket chamber further comprises a control port adapted to receive oil pressure and a resilient member disposed at a side opposite to the control port such that said valve spool slides horizontally by mutual action and reaction of the control pressure and resilient member.

6. The spool valve as defined in claim 5, wherein said resilient member is a round coil spring.
